(19) United States
(12) Patent Application Publication
(10) Pub. No.: US 2015/0325228 A1
(43) Pub. Date: Nov. 12, 2015

(54) ULTRASONIC TRANSDUCER USING FERROELECTRIC POLYMER

(71) Applicant: UNIVERSITY OF ULSAN FOUNDATION FOR INDUSTRY COOPERATION, ULSAN (KR)

(72) Inventors: Seung Tae CHOI, Busan (KR); Cheon Ho PARK, Pohang (KR); Yong Ju MOON, Daegu (KR)

(21) Appl. No.: 14/710,264

(22) Filed: May 12, 2015

(30) Foreign Application Priority Data
May 12, 2014 (KR) 10-2014-0056706

(51) Int. Cl. G10K 11/00; B32B 37/12

(52) U.S. Cl. CPC G10K 11/00; B32B 37/1207; B32B 2037/1223

(57) ABSTRACT

An ultrasound transducer includes a highly crystalline film, an upper electrode, a lower electrode, a first low melting point polymer film disposed between the highly crystalline film and the upper electrode, and a second low melting point polymer film disposed between the highly crystalline film and the lower electrode.

### CROSS-REFERENCE TO RELATED APPLICATION

This application claims priority from and the benefit of Korean Patent Application No. 10-2014-0056706, filed on May 12, 2014, which is hereby incorporated by reference in its entirety.

### BACKGROUND

1. Field

The present invention relates to an ultrasonic transducer using a ferroelectric polymer. More specifically, the present invention relates to an ultrasonic transducer using a ferroelectric polymer which may realize a thin and uniform adhesive layer having improved thermal stability and a thickness of about 1 μm.

2. Discussion of the Background

Ultrasound transducers have been manufactured using highly crystalline poly(vinylidene fluoride-trifluoroethylene) (P(VDF-TrFE)) films. Generally, highly crystalline P(VDF-TrFE) films have excellent thermal stability at high temperatures as compared to other forms of P(VDF-TrFE) films. However, a highly crystalline P(VDF-TrFE) film may break easily compared to other P(VDF-TrFE) films. In addition, highly crystalline P(VDF-TrFE) films may be easily broken, have poor adhesive strength, and have high surface roughness as compared with other P(VDF-TrFE) films.

As an illustrative ultrasonic transducer technology using a polymer, US Patent Registration U.S. Pat. No. 5,254,296 discloses a method for improving piezoelectric and dielectric properties of polyvinylidine fluoride (PVDF) films.

US Patent Registration U.S. Pat. No. 7,923,064 discloses a method of preparing an electroactive polymer.

In addition, US Patent Registration U.S. Pat. No. 7,454,024 discloses a system and a method for design and fabrication of a high-frequency transducer.

### SUMMARY

An embodiment of the present invention includes an ultrasonic transducer comprising a thermally stable ferroelectric polymer disposed as a thin and uniform adhesive layer. The thermally stable ferroelectric polymer may have a thickness of about 1 μm.

An embodiment of the ultrasonic transducer includes a low melting point PVDF-based polymer film.

Layers in the ultrasonic transducer may be bonded at a temperature about 5 to 10° C. lower than the melting temperature of the low melting point PVDF-based polymer film.

Bonding may be possible by partial melting of the low melting point PVDF-based polymer film.

The low melting point PVDF-based polymer film may be used as an adhesive layer. The low melting point PVDF-based polymer film may also improve performance of the ultrasonic transducer due to electric dipoles present in the low-melting point PVDF-based polymer film.

An ultrasound transducer including the low melting point PVDF-based polymer film may perform better than an ultrasound transducer including dielectric an adhesive layer that does not contribute to the piezoelectric function of the transducer.

### BRIEF DESCRIPTION OF THE DRAWINGS

FIG. 1 illustrates a configuration of an ultrasonic transducer using a ferroelectric polymer according to an embodiment of the present invention.

FIG. 2 illustrates a configuration of an ultrasonic transducer using a ferroelectric polymer according to another embodiment of the present invention.

FIG. 3 is a flowchart illustrating a process of manufacturing a highly crystalline poly(vinylidene fluoride-trifluoroethylene) (P(VDF-TrFE)) film according to an embodiment of the present invention.

FIG. 4 is an X-ray diffraction analysis graph of a highly crystalline P(VDF-TrFE) film manufactured by the process of FIG. 3.

### DETAILED DESCRIPTION OF THE ILLUSTRATED EMBODIMENTS

Hereinafter, an ultrasonic transducer comprising a ferroelectric polymer according to the present invention will be described with reference to the accompanying drawings.

An ultrasonic transducer comprising the ferroelectric polymer may include a highly crystalline film. The highly crystalline P(VDF-TrFE)) film may include a P(VDF-TrFE) film prepared with the special film fabrication processes including filtering process, stretching process, and annealing process described in this invention in order to maximize the crystallinity of the P(VDF-TrFE) film. The highly crystalline film may be a highly crystalline poly(vinylidene fluoride-trifluoroethylene) (P(VDF-TrFE)) film. The highly crystalline film may be disposed in a single-layer or multiple layers.

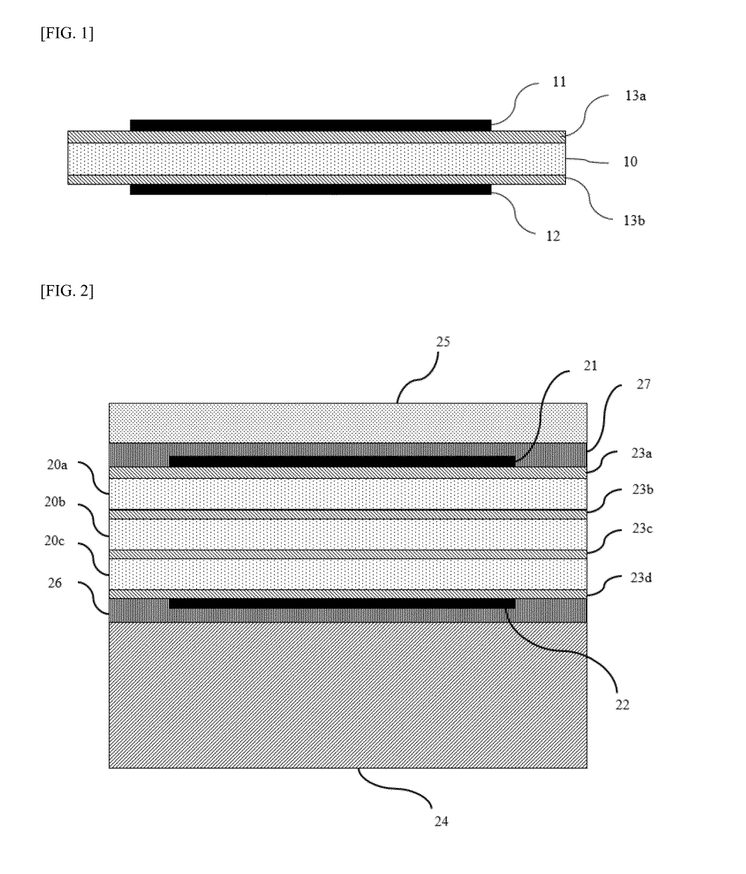

Referring to FIG. 1, an embodiment of an ultrasonic transducer includes a single highly crystalline film 10 layer. The ultrasonic transducer according to the embodiment includes a single highly crystalline film 10, an upper electrode 11 disposed above an upper surface of the highly crystalline film 10, a lower electrode 12 disposed below a lower surface of the highly crystalline film 10. A first low melting point polymer film 13a is disposed between the highly crystalline film 10 and the upper electrode 11, the first low melting point polymer film 13a bonding the highly crystalline film 10 to the upper electrode 11. A second low melting point polymer film 13b is disposed between the highly crystalline film 10, the second low melting point polymer film 13b bonding the highly crystalline film 10 to the lower electrode 12. Materials comprising the first and second low melting point polymer films 13a and 13b may be ferroelectric and include electric dipoles. The first and second low melting point polymer films 13a and 13b may be polyvinylidene fluoride (PVDF)-based films.

In an embodiment, the highly crystalline film 10 may be formed to be highly crystalline through a stretching process.

Referring to FIG. 2, another embodiment includes a plurality of highly crystalline films 20a, 20b, and 20c, an upper electrode 21, a lower electrode 22, a plurality of low melting point polymer films 23a, 23b, 23c, and 23d, a support material 24, an impedance coupling layer 25, an insulation layer 26, and an adhesive layer 27.

The plurality of highly crystalline films 20a, 20b, and 20c are disposed as a plurality of layers. The plurality of highly crystalline films may include a first highly crystalline film 20a, a second highly crystalline film 20b, and a third highly crystalline film 20c. Each of the highly crystalline films 20a, 20b, and 20c may be a highly crystalline P(VDF-TrFE) film.

The upper electrode 21 is disposed above the first highly crystalline film 20a.

The lower electrode 22 disposed under the third highly crystalline film 20c.

The plurality of low melting point polymer films 23a, 23b, 23c, and 23d may include a first low melting point polymer film 23a, a second low melting point polymer film 23b, a third low melting point polymer film 23c, and a fourth low melting point polymer film 23d. The first low melting point polymer film 23a may be disposed between the upper electrode 21 and the first highly crystalline film 20a. The first low melting point polymer film 23a may bond the upper electrode 21 to the first highly crystalline film 20a.

The fourth low melting point polymer film 23d may be disposed between the lower electrode 21 and the third highly crystalline film 20c. The fourth low melting point polymer film 23d may bond the lower electrode 22 to the third highly crystalline film 20c.

Each of the plurality of low melting point polymer films 23a, 23b, 23c, and 23d may be polyvinylidene fluoride (PVDF)-based films.

The highly crystalline films 20a, 20b, and 20c may be formed in multiple layers, for example, three layers, as illustrated in FIG. 2. However, the highly crystalline films 20a, 20b, and 20c are not limited to a triple-layer structure but may be disposed in three or more layers. Other PVDF-based polymer films may be used for the highly crystalline films, but P(VDF-TrFE) films are appropriate because P(VDF-TrFE) films may achieve maxmum polarization. Thus, in some embodiments, the highly crystalline films 20a, 20b, and 20c are highly crystalline P(VDF-TrFE) films.

The first low melting point polymer film 23a may firmly bond the first highly crystalline film 20a and the upper electrode 21, and fourth low melting point polymer film 23d may firmly bond the highly crystalline film 10 and the lower electrode 22. In addition, the low melting point polymer films 23a, 23b, 23c, and 23d may improve performance of the ultrasonic transducer due to the ferroelectricity of the low melting point polymer films 23a, 23b, 23c, and 23d, and electric dipoles present in the low melting point polymer films 23a, 23b, 23c, and 23d. The low melting point polymer films 23a, 23b, 23c, and 23d may be adhesive layers. In addition, the low melting point polymer films 23a, 23b, 23c, and 23d may each have a thickness of approximately 1 μm.

The low melting point polymer films 23a, 23b, 23c, and 23d may each have a melting point approximately 20 to 40° C. lower than the melting points of the highly crystalline films 20a, 20b, and 20c.

The low melting point polymer films 23a, 23b, 23c, and 23d may be PVDF-based polymer films. Each of the low melting point polymer films 23a, 23b, 23c, and 23d may include materials such as poly(vinylidene fluoride-trifluoroethylene-chlorofluoroethylene) (P(VDF-TrFE-CFE)), poly(vinylidene fluoride-trifluoroethylene-chlorotrifluoroethylene) (P(VDF-TrFE-CTFE)), poly(vinylidene fluoride-trifluoroethylene) (P(VDF-TrFE)), poly(vinylidene fluoride-hexafluoroacetone) (P(VDF-HFA)), poly(vinylidene fluoride-trifluoroethylene-hexafluoroacetone) (P(VDF-TrFE-HFP)), or a combination thereof. The low melting point polymer films 23a, 23b, 23c, and 23d may have lower melting points than the highly crystalline films 20a, 20b, and 20c. For example, materials such as P(VDF-TrFE-CFE), P(VDF-TrFE-CTFE), P(VDF-TrFE), P(VDF-HFA) and P(VDF-TrFE-HFP) have lower melting points than a material of the highly crystalline films 20a, 20b, and 20c such as P(VDF-TrFE).

In an embodiment, the plurality of low melting point polymer films 23a, 23b, 23c, and 23d each have melting temperatures of about 120° C. or lower.

The low melting point polymer films 23a, 23b, 23c, and 23d may be manufactured using materials that have a lower melting point than P(VDF-TrFE), and may be melted at a lower temperature than the highly crystalline films 20a, 20b, and 20c and other materials comprising the transducer. Thus, the low melting point polymer films 23a, 23b, 23c, and 23d may serve as adhesives between the other materials comprising the transducer. Accordingly, the low melting point polymer films 23a, 23b, 23c, and 23d may effectively and firmly bond the highly crystalline films 20a, 20b, and 20c and the electrodes when the low melting point polymer films 23a, 23b, 23c, and 23d are melted, e.g., selectively, at a lower temperature than the melting points of the highly crystalline films 20a, 20b, and 20c and the upper and lower electrodes 21 and 22.

In a specific embodiment, the low melting point polymer films 23a, 23b, 23c, and 23d are PVDF-based polymer films. When thermal energy and pressure are applied to the low melting point polymer films 23a, 23b, 23c, and 23d to raise the temperature of the low melting point polymer films 23a, 23b, 23c, and 23d to approximately 110° C., the low melting point polymer films 23a, 23b, 23c, and 23d may be partially melted. Accordingly the low melting point polymer films 23a, 23b, 23c, and 23d may serve as an adhesive which strongly bonds highly crystalline films 20a, 20b, and 20c and the upper and lower electrodes 21 and 22.

Thus, the low melting point polymer films 23a, 23b, 23c, and 23d may be partially melted at a temperature that does not change the phase of the highly crystalline films 20a, 20b, and 20c. The low melting point polymer films 23a, 23b, 23c, and 23d may serve as adhesive layers and also improve performance of the ultrasonic transducer. Electric dipoles may be present in the low melting point polymer films 23a, 23b, 23c, and 23d, thereby improving the performance of the ultrasonic transducer. The low melting point polymer films 23a, 23b, 23c, and 23d may be ferroelectric, thereby improving the performance of the ultrasonic transducer.

The highly crystalline films 20a, 20b, and 20c between the upper electrode 21 and the lower electrode 22 may have a triple-layer structure as illustrated in FIG. 2. The second low melting point polymer film 23b is disposed between the first highly crystalline film 20a and the second highly crystalline film 20b, and may bond the first highly crystalline film 20a to the second highly crystalline film 20b.

The third low melting point polymer film 23c is disposed between the second highly crystalline film 20b and the third highly crystalline film 20c, and may bond the first highly crystalline film 20a to the second highly crystalline film 20b. Thus, the low melting point polymer films 23a, 23b, 23c, and 23d may bond the highlycrystalline films 20a, 20b, and 20c to other materials.

The highly crystalline films 20a, 20b, and 20c may each include a PVDF-based polymer that contains fluorine, and thus may have poor adhesive strength. However, the low melting point polymer films 23a, 23b, 23c, and 23d may also include a PVDF-based polymer and adhere strongly to the highly crystalline films 20a, 20b, and 20c. The highly crystalline films 20a, 20b, and 20c may include a polymer represented by P(VDFₓ-TrFE(ᵢ₋ₓ)), where x is 70 to 80

In an embodiment, the highly crystalline films 20a, 20b, and 20c may be formed to be highly crystalline through a stretching process.

The upper electrode 21 and the lower electrode 22 may comprise a metal selected from aluminum, gold, copper, nickel, chromium, or a combination thereof.

Each of the highly crystalline films 20a, 20b, and 20c may be comprised of a highly crystalline P(VDF-TrFE) film. For reference, P(VDF-TrFE) is a combinₐtion _{of tw}o molecules: vinylidene fluoride (VDF) and trifluoroethylene (TrFE). P(VDF-TrFE) is a PVDF-based polymer, and exhibits greater piezoelectricity than other piezoelectric polymers. For reference, P(VDF-TrFE) has a Curie temperature of 122° C. and a melting temperature of 150° C.

As illustrated in FIG. 2, a support material 24, such as a substrate, is disposed under the lower electrode 22 to support the deposition of piezoelectric materials. The support material 24 may be a silicone substrate, a PVDF substrate, or a metal substrate.

An insulation layer 26 may be disposed between the lower electrode 22 and the support material 24.

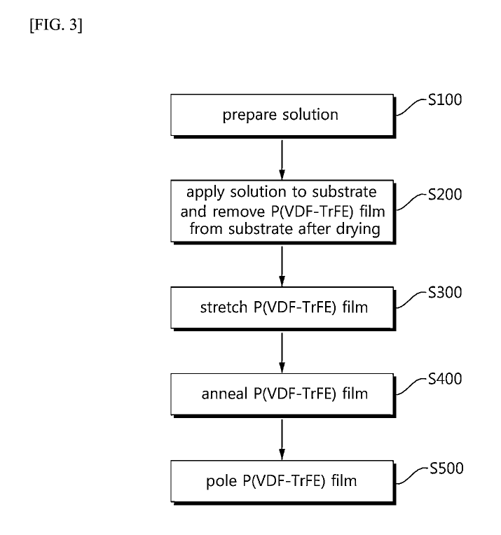

An impedance coupling layer 25 may be disposed above the upper electrode 21. The impedance coupling layer 25 and the upper electrode 21 may be bonded to each other by an adhesive layer 27. Next, a process of manufacturing a highly crystalline P(VDF-TrFE) film will be described. As illustrated in FIG. 3, the process of manufacturing the highly crystalline P(VDF-TrFE) film includes a first step S100 of preparing a solution, a second step S200 of applying the solution to a substrate and removing a P(VDF-TrFE) film from the substrate after drying, a third step S300 of stretching the P(VDF-TrFE) film, a fourth step S400 of annealing the P(VDF-TrFE) film and a fifth step S500 of poling the P(VDF-TrFE) film.

Specifically, the first step S100 is a step of preparing a P(VDF-TrFE) solution, in which P(VDF-TrFE) powder is mixed with an methyl ethyl ketone (MEK) solution. The P(VDF-TrFE) solution is subjected to a filtering process for filtering particles having a set size or grater. The filtering process may remove undissolved particles and impurities.

The second step S200 is a step of applying the P(VDF-TrFE) solution to a substrate and removing the P(VDF-TrFE) film from the substrate when the P(VDF-TrFE) solution is dried. Here, natural drying or drying with gas, such as nitrogen gas (N₂), may be used.

The third step S300 is a step of stretching the P(VDF-TrFE) film. The P(VDF-TrFE) film may be stretched for approximately five hours while applying a warm current of air thereto. In an embodiment, the P(VDF-TrFE) film may be supported by a roller that draws the P(VDF-TrFE) film in one direction. While the P(VDF-TrFE) film is drawn, a warm current of air is applied to the P(VDF-TrFE) film to maximize stretching.

The fourth step S400 is a step of annealing the stretched P(VDF-TrFE) film. In an embodiment, the free-standing P(VDF-TrFE) film is annealed at 140° C. The annealing process may maximize the crystallinity of the P(VDF-TrFE) film, thereby improving the piezoelectric properties of the P(VDF-TrFE) film.

The fifth step S500 is a step of poling the P(VDF-TrFE) film by applying a high electric field to the P(VDF-TrFE) film to align electric dipole moments in the P(VDF-TrFE) film. The poling may be applied after the P(VDF-TrFE) film has been manufactured, but before the P(VDF-TrFE) film has been operated, so as to improve the piezoelectric characteristics of the P(VDF-TrFE) film during operation. Poling may include applying thermal energy to the P(VDF-TrFE) film, and a voltage across the P(VDF-TrFE) film.

The highly crystalline P(VDF-TrFE) film obtained via the foregoing process according to the present invention may have a thin thickness and a rough surface as compared to common P(VDF-TrFE) films.

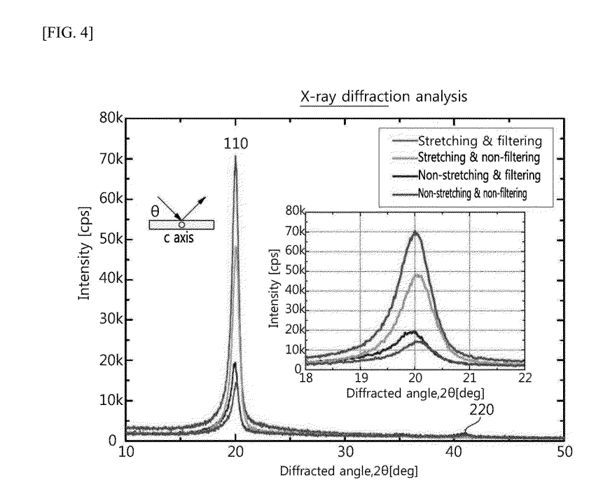

A graph illustrated in FIG. 4 shows that a highly crystalline P(VDF-TrFE) film subjected to both stretching and filtering has a higher X-ray diffraction (XRD) intensity and thus superior crystallinity.

The highly crystalline P(VDF-TrFE) film according to the present invention may be defined as P(VDFₓ-TrFE₍₁₋ₓ₎) when x is 0.7 to 0.8. In the highly crystalline P(VDF-TrFE) film, electric dipoles are arranged at an angle of 30 degrees with respect to a surface of the film. The highly crystalline P(VDF-TrFE) film is a highly crystalline material and therefore has high energy barriers with respect to reverse arrangement of electric polarization and phase change, thus exhibiting excellent thermal stability as compared with common P(VDF-TrFE) films.

However, the highly crystalline P(VDF-TrFE) film according to the present invention, when stretched in a drawn direction, may be easy to break in the drawn direction as compared to other P(VDF-TrFE) films. Further, the highly crystalline P(VDF-TrFE) film exhibits inferior adhesive strength to that of common P(VDF-TrFE) films and has a slightly rough surface due to the stretching process.

[53] Thus, in order to address these technical disadvantages, the present invention uses the first low melting point PVDF-based polymer film 23a as an adhesive layer between the highly crystalline P(VDF-TrFE) film 20a and the upper electrode 21, and the fourth low melting point PVDF-based polymer film 23a as an adhesive layer between the highly crystalline P(VDF-TrFE) film 20c and the lower electrode 22 so as to easily bond the highly crystalline P(VDF-TrFE) films 20a, 20b, and 20c.

The present invention allows bonding at a temperature about 5 to 10° C. lower than the melting temperature of the low melting point polymer films 23a, 23b, 23c, and 23d when the low melting point polymer films are PVDF-based polymer films. The present invention also allows bonding by partial melting of the PVDF-based polymers. In addition, the present invention may realize a thin and uniform adhesive layer having a thickness of about 1 μm.

The low melting point PVDF-based polymer films 23a, 23b, 23c, and 23d used as adhesive layers not only serve as an adhesive layers but also increase performance of an ultrasonic transducer due to electric dipoles present in the low melting point PVDF-based polymer films 23a, 23b, 23c, and 23d. Further, the low melting point PVDF-based polymer films 23a, 23b, 23c, and 23d may enhance the function of an ultrasound transducer, unlike common transducer adhesives.

What is claimed is:

1. An ultrasound transducer, comprising:
a highly crystalline film;
an upper electrode;
a lower electrode;
a first low melting point polymer film disposed between the highly crystalline film and the upper electrode; and
a second low melting point polymer film disposed between the highly crystalline film and the lower electrode.

2. The ultrasound transducer of claim 1, wherein the highly crystalline film is a first highly crystalline film, and the ultrasound transducer further comprises:
a second highly crystalline film; and
a third highly crystalline film coupled to the lower electrode by a third low melting point polymer film,
wherein the first low melting point polymer film couples the first highly crystalline film to the upper electrode.

3. The ultrasound transducer of claim 2, further comprising:
an impedance coupling layer adhered to the upper electrode.

4. The ultrasound transducer of claim 3, further comprising:
a support material; and
an insulation layer disposed between the lower electrode and the support material.

5. The ultrasound transducer of claim 2,
wherein the first low melting point polymer film is coupled between the first highly crystalline film and the upper electrode,
wherein the second low melting point polymer film is coupled between the first highly crystalline film and the second highly crystalline film,
wherein a third low melting point polymer film is coupled between the second highly crystalline film and the third highly crystalline film, and
wherein a fourth low-melting point polymer film is coupled between the third highly crystalline film and the lower electrode.

6. The ultrasound transducer of claim 1, wherein the highly crystalline film includes poly(vinylidene fluoride-trifluoroethylene) (P(VDF-TrFE)).

7. The ultrasound transducer of claim 6, wherein the first low melting point polymer film and the second low melting point polymer film include polyvinylidine fluoride (PVDF).

8. The ultrasound transducer of claim 6, wherein the highly crystalline film is a stretched P(VDF-TrFE) film.

9. A method of manufacturing an ultrasound transducer, comprising:
forming a P(VDF-TrFE) film by drying a P(VDF-TrFE) solution;
adhering the P(VDF-TrFE) film to an electrode by using a low melting point polymer film between the P(VDF-TrFE) film and the electrode.

10. The method of claim 9, further comprising:
stretching the P(VDF-TrFE) film.

11. The method of claim 10, wherein the P(VDF-TrFE) film is stretched while applying a warm current of air to the P(VDF-TrFE) film.

12. The method of claim 10, further comprising:
annealing the P(VDF-TrFE) film after the P(VDF-TrFE) film is stretched.

13. The method of claim 12, wherein the stretched P(VDF-TrFE) film is annealed at 140° C.

14. The method of claim 9, wherein electric dipoles in the P(VDF-TrFE) film are aligned by poling the film.
